(19) United States
(12) Patent Application Publication
(10) Pub. No.: US 2015/0248146 A1
(43) Pub. Date: Sep. 3, 2015

(54) BRACKET MECHANISM FOR DATA STORAGE DEVICES

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YU-MING XIAO, Wuhan (CN); LIANG-CHIN WANG, New Taipei (TW); ZAN LI, Wuhan (CN); XIAO-FEI ZHOU, Wuhan (CN)

(21) Appl. No.: 14/524,871

(22) Filed: Oct. 27, 2014

(30) Foreign Application Priority Data
Feb. 28, 2014 (CN) 201410071107.5

(51) Int. Cl. G06F 1/18

(52) U.S. Cl. CPC G06F 1/183; G06F 1/181

(57) ABSTRACT

A bracket mechanism includes a tray, and a blocking member. The tray defines a receiving space configured to receive a first data storage device. The tray includes a first sidewall. The first sidewall defines an installation hole, and a latching member located in the first storage device is engaged in the installation hole. The blocking member is engaged with the first tray and includes a limiting piece, and the limiting piece is received in the installation hole and resists the latching member to prevent the latching member from moving in the installation hole relative to the first sidewall.

### CROSS-REFERENCE TO RELATED APPLICATIONS

This application claims priority to Chinese Patent Application No. 201410071107.5 filed on Feb. 28, 2014, the contents of which are incorporated by reference herein.

### FIELD

The subject matter herein generally relates to a bracket mechanism.

### BACKGROUND

Electronic devices, such as computers, include a plurality of data storage devices. The data storage devices can be hard disk drives, floppy disks, and so on.

### BRIEF DESCRIPTION OF THE DRAWINGS

Implementations of the present technology will now be described, by way of example only, with reference to the attached figures.

FIG. 1 is an exploded, isometric view of a bracket mechanism, a first data storage device, and a second data storage device.

FIG. 2 is an assembled view of the bracket mechanism, the first data storage device and the second data storage device.

FIG. 3 is cross-sectional view of the bracket mechanism of FIG. 4, taken along the line III-III of FIG. 2.

FIG. 4 is an isometric view of the bracket mechanism of FIG. 1.

FIG. 5 is similar to FIG. 4, but viewed from a different angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

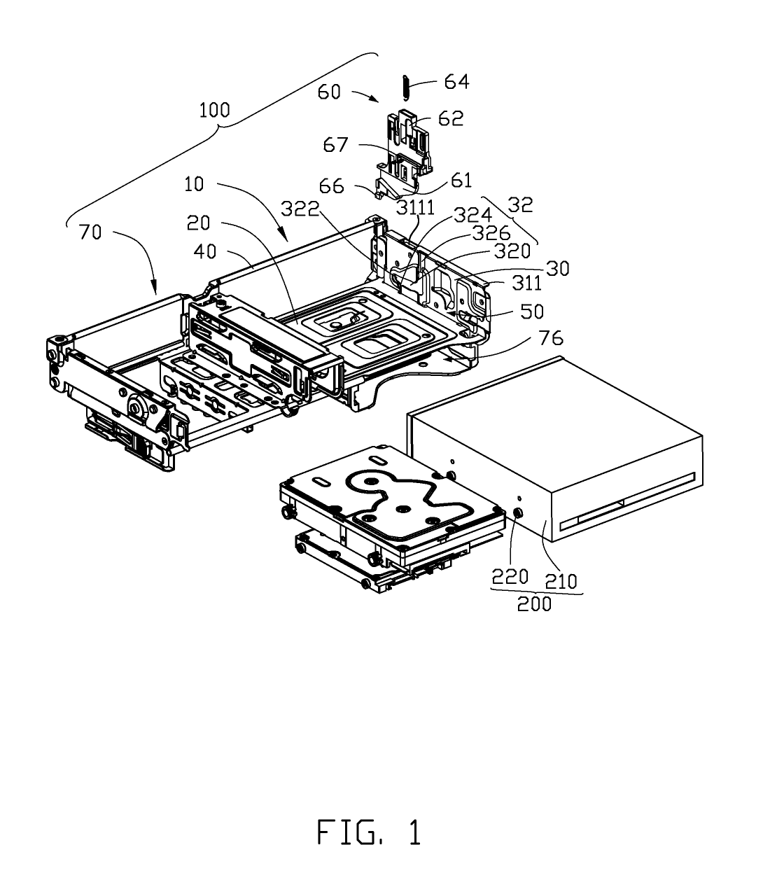

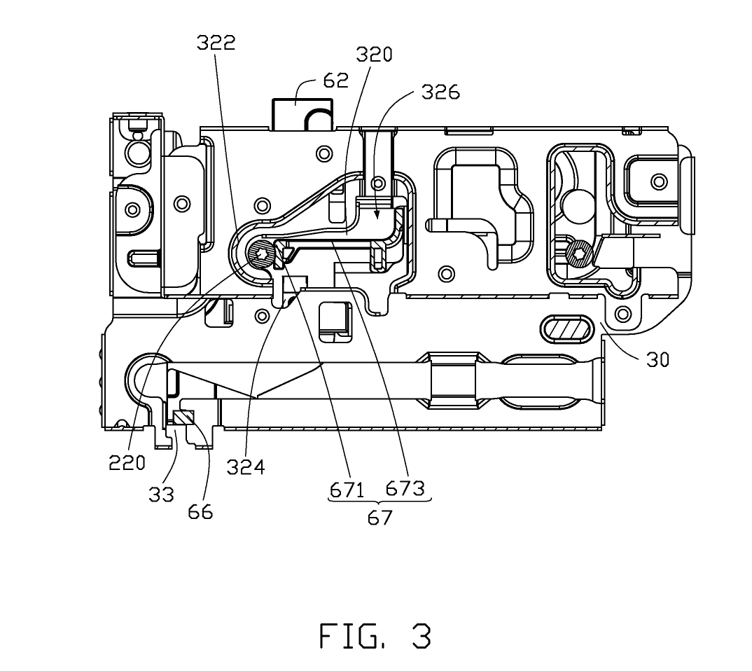

FIG. 1-3 illustrates a bracket mechanism 100 in accordance with an example embodiment. The bracket mechanism 100 can include a first tray 10, a blocking member 60, a resilient member 64, and a second tray 70 coupled to the first tray 10. The first tray 10 can receive a first data storage device 200. The second tray 70 can receive a second data storage device 300. The first data storage device 200 can have a size different from the second data storage device 300 and can include two side plates 210. A latching member 220 is located on each side plate 210.

The first tray 10 can include a first bottom plate 20, a first sidewall 30, a second sidewall 31, and a first beam 40. The first sidewall 30 and the second sidewall 31 can extend upwards from opposite edges of the first bottom plate 20. The first beam 40 can be connected to rear portions of the first sidewall 30 and the second sidewall 31. The first bottom plate 20, the first sidewall 30, the second sidewall 31, and the first beam 40 can cooperatively define a first receiving space 50 configured to receive the first data storage device 200. A flange 311 can extend outwards from a top edge of the first sidewall 30 and can be substantially perpendicular to the first sidewall 30. A through hole 3111 is defined in the flange 311.

The first sidewall 30 defines an installation hole 32 corresponding to the latching member 220 and adjacent to the through hole 3111. The installation hole 32 can include a narrow portion 322, a wide portion 320, a receiving portion 324, and an exit 326. The wide portion 320 communicates with the narrow portion 322. In at least one embodiment, the width of the narrow portion 322 is less than a width of the wide portion 320. The receiving portion 324 communicate with the wide portion 320 can define a first extension direction. The exit 326 can be in communication with the wide portion 320 and has a second extension direction and can be opposite to the second extension direction. A cutout 33 can be defined in a bottom portion of the first sidewall 30 adjacent to a front end of the first tray 10. An engaging portion 35 is located on an outer side of the first sidewall 30. A second receiving space 76 can be defined in the bottom of the first tray 10 for receiving a third data storage device (not shown).

The blocking member 60 can include a sliding board 61, an operation portion 62, and a hook 66. The sliding board 61 can be substantially parallel with the first sidewall 30 and can define an engaging hole 611. The operation portion 62 can extend from a top portion of the sliding board 61. The hook 66 can be located on a bottom portion of the sliding board 61. A limiting piece 67 can protrude from the sliding board 61 and can substantially perpendicular to the sliding board 61. The limiting piece 67 can include a limiting tab 671 and a guiding strip 673. The limiting tab 671 can extend from one end of the guiding strip 673. In at least one embodiment, the guiding strip 673 can be substantially perpendicular to the limiting tab 671 and substantially parallel with the first bottom plate 20.

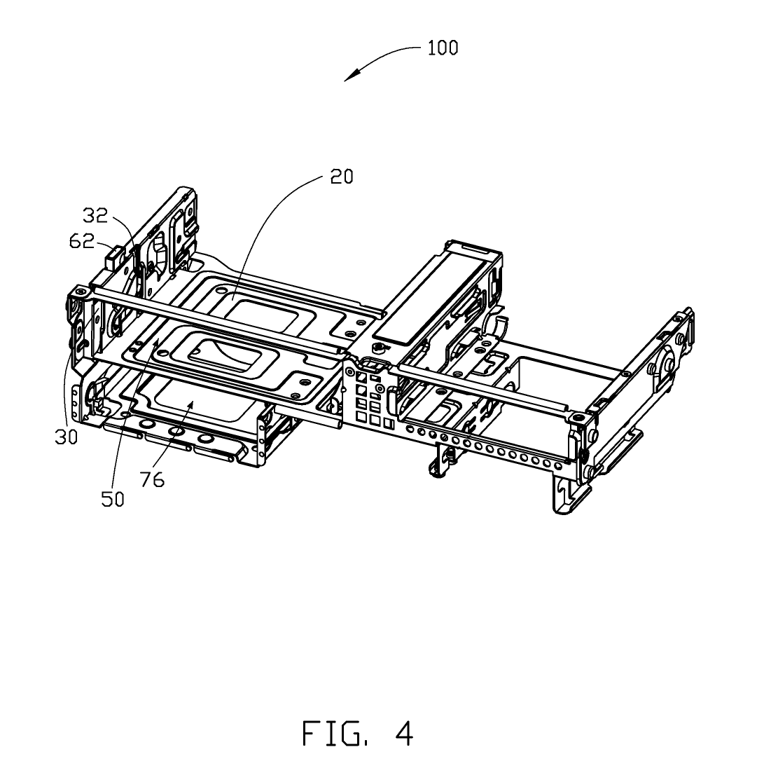

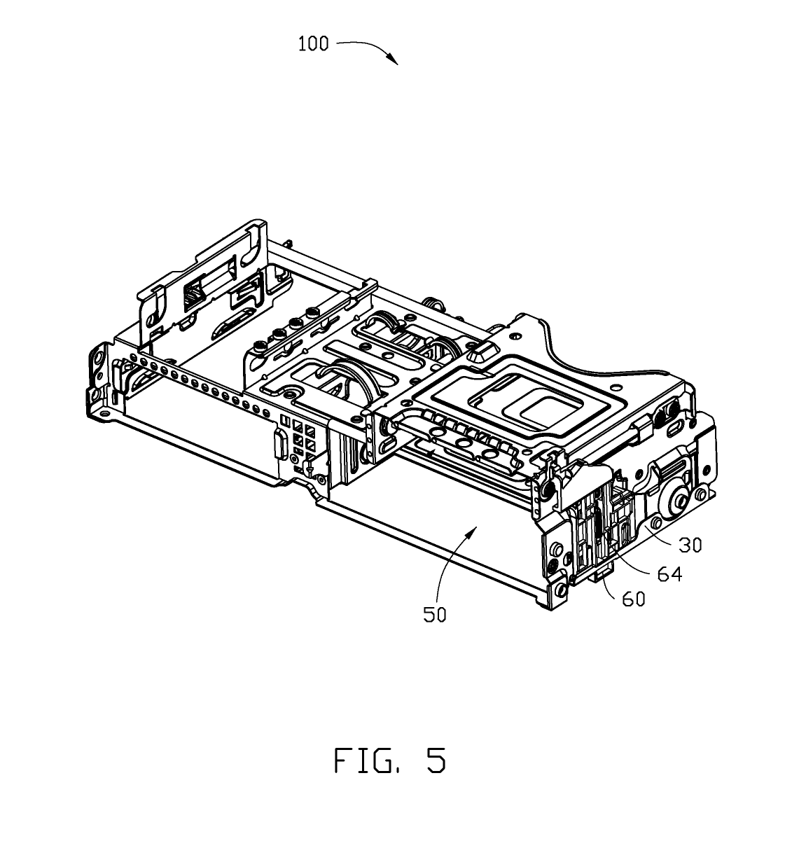

FIGS. 4 and 5 illustrate that in assembly of the blocking member 60, the operation portion 62 can extend through the through hole 3111 and can be partially exposed out of the flange 311. The limiting piece 67 is received in the wide portion 320. The hook 66 can extend through the cutout 33 and can be engaged with an edge of the cutout 33. Therefore the engaging hole 611 can be located below the engaging portion 35. A first end portion of the resilient member 64 can be engaged with the engaging portion 35, and a second portion opposite to the first portion of the resilient member 64 can be engaged in the engaging hole 611. Therefore the blocking member 60 can be hanged on the first sidewall 30 via the resilient member 64.

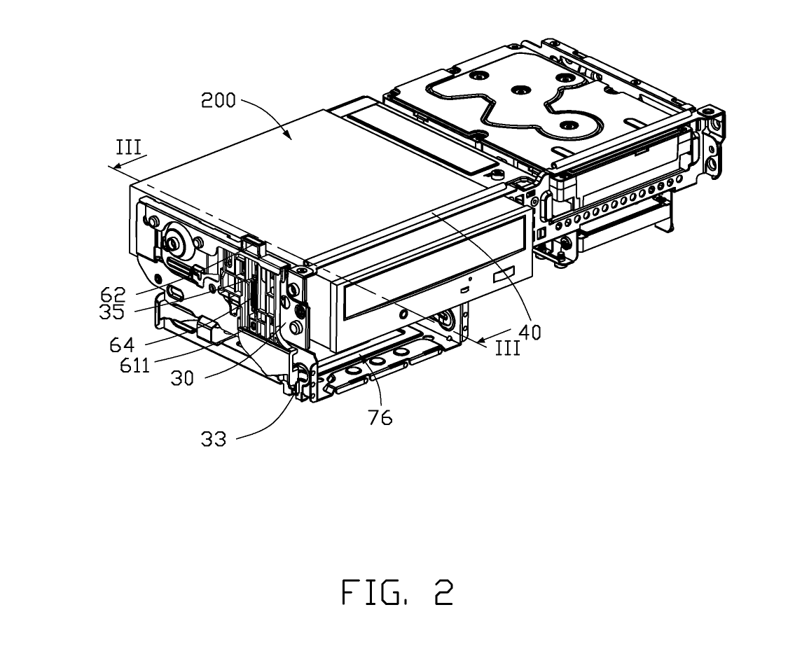

FIG. 2 illustrates that in assembly of the first data storage device 200, the latching member 220 can be inserted into the wide portion 320 through the exit 326. The first data storage device 200 can be pushed towards the first beam 40, and the latching member 220 is moved along the guiding strip 673. The guiding strip 673 can be pushed to slide the blocking member 60 in a first direction towards the first bottom plate 20, until the latching member 220 is located in a first position, where the latching member 20 can be disengaged from the limiting piece 67 to be engaged into the narrow portion 322. The resilient member 64 can resiliently rebound to move the blocking member 60 towards a second direction opposite to the first direction, until the limiting tab 671 resists the latching member 220, to prevent the latching member 220 from disengaging from the narrow portion 322.

When the first data storage device 200 needs to be detached, the operation portion 62 can be pressed to move the blocking member 60 towards the first direction, until the limiting tab 671 disengages from the latching member 220 and can be received in the receiving portion 324. Simultaneously, the latching member 220 slides from the narrow portion 322 into the wide portion 320 to be in a second position. Thus, the latching member 220 can be detached from the installation hole 32 through the exit 326.

The embodiments shown and described above are only examples. Many details are often found in the art such as the other features of a bracket mechanism. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A bracket mechanism comprising:
a tray defining a receiving space configured to receive a first data storage device, the tray comprising a first sidewall, the first sidewall defining an installation hole, and a latching member secured to the first storage device engaged in the installation hole; and
a blocking member engaged with the tray and comprising a limiting piece, and the limiting piece received in the installation hole and abutting the latching member to prevent the latching member from moving in the installation hole relative to the first sidewall.

2. The bracket mechanism of claim 1, wherein the installation hole comprises a narrow portion, the latching member engaged in the narrow portion.

3. The bracket mechanism of claim 2, wherein the installation hole further comprises a wide portion in communication with the narrow portion, and the limiting piece is received in the wide portion and is movable along the blocking member to disengage from the lathing portion.

4. The bracket mechanism of claim 3, wherein the installation hole further comprises a receiving portion in communication with the wide portion, and the limiting piece is received in the receiving portion after disengaging from the wide portion.

5. The bracket mechanism of claim 4, wherein the first sidewall further defines an exit in communication with the wide portion, and the latching member is slidable to disengage from the installation hole through the exit.

6. The bracket mechanism of claim 5, wherein the receiving portion defines a first extension direction, the exit has a second extension direction, and the first extension direction is opposite to the second extension direction.

7. The bracket mechanism of claim 3, wherein a width of the narrow portion is less than a width of the wide portion.

8. The bracket mechanism of claim 1, wherein the blocking member comprises a sliding board, and the limiting piece is located on the sliding board and is substantially perpendicular to the sliding board.

9. The bracket mechanism of claim 8, further comprising a resilient member, wherein a first portion of the resilient member is engaged with the first sidewall, and a second portion of the resilient member is engaged with the sliding board.

10. The bracket mechanism of claim 9, wherein an operation portion extends from the sliding portion, a hook is located on the sliding board, the first sidewall defines a positioning hole, and the hook is engaged with an edge of the position hole.

11. A bracket mechanism comprising:
a first tray defining a receiving space configured to receive a first data storage device, the first tray comprising a first sidewall, the first sidewall defining an installation hole, and a latching member located on the first storage device and being engaged in the installation hole; and
a blocking member comprising a limiting piece;
wherein the blocking member is slidable relative to a first position and a second position, in the first position, the limiting piece abuts the latching member; and
in the second position, the limiting piece is disengaged from the latching member.

12. The bracket mechanism of claim 11, wherein the installation hole comprises a narrow portion, and the latching member is engaged in the narrow portion.

13. The bracket mechanism of claim 12, wherein the installation hole further comprises a wide portion in communication with the narrow portion and a receiving portion in communication with the wide portion; in the first position, the limiting piece is received in the wide portion; and in the second position, the limiting piece is disengaged from the wide portion and received in the receiving portion.

14. The bracket mechanism of claim 13, wherein the first sidewall further defines an exit in communication with the wide portion, and the latching member is slidable to disengage from the installation hole through the exit.

15. The bracket mechanism of claim 14, wherein the receiving portion defines a first extension direction, the exit has a second extension direction, and the first extension direction is opposite to the second extension direction.

16. The bracket mechanism of claim 13, wherein the width of the narrow portion is less than the width of the wide portion.

17. The bracket mechanism of claim 11, wherein the blocking member comprises a sliding board, and the limiting piece is located on the sliding board and is substantially perpendicular to the sliding board.

18. The bracket mechanism of claim 17, further comprising a resilient member, wherein a first portion of the resilient member is engaged with the first sidewall, and a second portion of the resilient member is engaged with the sliding board.

19. The bracket mechanism of claim 18, wherein an operation portion extends from the sliding portion, a hook is located on the sliding board, the first sidewall defines a cutout, and the hook is engaged with an edge of the position hole.

20. The bracket mechanism of claim 11, further comprising a second tray connected to the first tray, wherein the second tray is configured to receive a second data storage device, and the first data storage device has a size different from the second data storage device.
